(19) United States
(12) Patent Application Publication
(10) Pub. No.: US 2026/0281179 A1
(43) Pub. Date: Sep. 17, 2026

(54) RDMA backend for Distributed System

(71) Applicant: Mellanox Technologies, Ltd., Yokneam (IL)

(72) Inventors: Moein Khazraee, Sunnyvale, CA (US); Vishwanath Venkatesan, Austin, TX (US); Subhadeep Bhattacharya, Santa Clara, CA (US); Timothy Stamler, Austin, TX (US); Artem Polyakov, New York, NY (US); Omri Kahalon, Calgary (CA); Adit Ranadive, Palo Alto, CA (US); Kapil Arya, Woodinville, WA (US)

(21) Appl. No.: 19/390,571

(22) Filed: Nov. 16, 2025

Related U.S. Application Data
(60) Provisional application No. 63/773,516, filed on Mar. 18, 2025.
(60) Provisional application No. 63/772,866, filed on Mar. 17, 2025.

(51) Int. Cl. H04L 67/1097; G06F 9/54

(52) U.S. Cl. CPC H04L 67/1097; G06F 9/541

(57) ABSTRACT

In one embodiment, a device includes at least one processor to execute a transfer backend plugin acting as an adaptor between a transfer agent and a hardware data transfer device, the transfer backend plugin being to initialize communication with a remote transfer backend plugin, exchange address information with the remote transfer backend plugin, register local memory for data transfers, exchange memory registration information with the remote transfer backend plugin, and interface with the hardware data transfer device to perform data transfers between the local memory and remote memory using at least one data transfer protocol, and a memory to store data used by the transfer backend plugin.

### RELATED APPLICATION INFORMATION

The present application claims benefit of US Provisional Patent Applications S/N 63/772,866 and 63/773,516of Khazraee, et al., filed 17 Mar. 2025, and 18 Mar. 2025, respectively, the disclosures of which are hereby incorporated herein by reference.

### FIELD OF THE DISCLOSURE

The present disclosure relates to distributed computing environments, and more particularly but not exclusively to managing memory transfers between computer nodes.

### BACKGROUND

Distributed computing environments have become increasingly prevalent in modern technological landscapes. These environments typically consist of multiple interconnected computer nodes that work together to perform complex computational tasks. Such systems are commonly employed in data centers, high-performance computing clusters, large-scale enterprise applications, and inference data centers.

In distributed computing environments, efficient data transfer between nodes is a crucial aspect of system performance. As computational workloads grow in complexity and scale, including tasks like large-scale inference, the ability to move data quickly and reliably between different parts of the system becomes increasingly important. This includes transfers between various types of memory, such as system memory, GPU memory, and storage devices.

Managing memory transfers in distributed systems presents several challenges. The heterogeneous nature of modern computing hardware, which may include CPUs, GPUs, and specialized accelerators optimized for inference, adds complexity to the task of coordinating data movement. Additionally, the diverse range of communication protocols and hardware interfaces used in these systems further complicates the process of efficiently transferring data between nodes.

### OVERVIEW

There is provided in accordance with an embodiment of the present disclosure, a device, comprising at least one processor to execute a transfer backend plugin acting as an adaptor between a transfer agent and a hardware data transfer device, the transfer backend plugin being to initialize communication with a remote transfer backend plugin, exchange address information with the remote transfer backend plugin, register local memory for data transfers, exchange memory registration information with the remote transfer backend plugin, and interface with the hardware data transfer device to perform data transfers between the local memory and remote memory using at least one data transfer protocol, and a memory to store data used by the transfer backend plugin.

Further in accordance with an embodiment of the present disclosure, the transfer backend plugin is to receive a transfer request from the transfer agent, the transfer request including information about source and destination memory locations, and translate the transfer request into device-specific commands to execute the transfer using a selected transfer protocol.

Still further in accordance with an embodiment of the present disclosure, the transfer backend plugin supports multiple transfer protocols including at least one of Remote Direct Memory Access (RDMA) over InfiniBand, RDMA over Converged Ethernet (RoCE), TCP/IP, User Datagram Protocol (UDP), or shared memory transfers, acting as an interface between the transfer agent and hardware data transfer devices implementing these protocols.

Additionally, in accordance with an embodiment of the present disclosure, the transfer backend plugin is to interface with different types of memory to transfer data between at least two of CPU memory, GPU memory, or accelerator memory.

Moreover, in accordance with an embodiment of the present disclosure, the transfer backend plugin is to prepare transfer descriptors based on a transfer request from the transfer agent, and submit the transfer descriptors to a communication library to interface with the hardware data transfer device to perform the data transfer.

Further in accordance with an embodiment of the present disclosure, the communication library is Universal Communication X (UCX), and the transfer backend plugin acts as an adaptor between the transfer agent and UCX.

Still further in accordance with an embodiment of the present disclosure, the hardware data transfer device is a Remote Direct Memory Access (RDMA) device.

Additionally, in accordance with an embodiment of the present disclosure, the hardware data transfer device is an Ethernet device.

Moreover, in accordance with an embodiment of the present disclosure, the transfer backend plugin is to support non-contiguous data transfers by receiving a transfer request from the transfer agent comprising multiple descriptors, each descriptor corresponding to a portion of non-contiguous data, and translating the request into multiple contiguous transfers for the hardware data transfer device to execute.

Further in accordance with an embodiment of the present disclosure, the transfer backend plugin is to interface with the hardware data transfer device to perform a write or atomic operation transferring data from the local memory to the remote memory, and send a notification to the remote transfer backend plugin upon completion of the write or atomic operation.

Still further in accordance with an embodiment of the present disclosure, the transfer backend plugin is to interface with the hardware data transfer device to perform a read or atomic operation transferring data from the remote memory to the local memory, and send a notification to the remote transfer backend plugin upon completion of the read or atomic operation.

Additionally, in accordance with an embodiment of the present disclosure, the transfer backend plugin is dynamically loadable and unloadable during runtime of the transfer agent, allowing adaptation to different hardware data transfer devices and transfer protocols.

There is provided in accordance with another embodiment of the present disclosure, a method for managing data transfers in a device, comprising executing a transfer backend plugin acting as an adaptor between a transfer agent and a hardware data transfer device, initializing, by the transfer backend plugin, communication with a remote transfer backend plugin, exchanging address information with the remote transfer backend plugin, registering local memory for data transfers, exchanging memory registration information with the remote transfer backend plugin, and interfacing with the hardware data transfer device to perform data transfers between the local memory and remote memory using at least one data transfer protocol.

Moreover, in accordance with an embodiment of the present disclosure, the method further comprises receiving a transfer request from the transfer agent, the transfer request including information about source and destination memory locations, and translating the transfer request into device-specific commands to execute the transfer using a selected transfer protocol.

Further in accordance with an embodiment of the present disclosure, the transfer backend plugin supports multiple transfer protocols including at least one of Remote Direct Memory Access (RDMA) over InfiniBand, RDMA over Converged Ethernet (RoCE), TCP/IP, User Datagram Protocol (UDP), or shared memory transfers, acting as an interface between the transfer agent and hardware data transfer devices implementing these protocols.

Still further in accordance with an embodiment of the present disclosure, performing data transfers includes interfacing with different types of memory to transfer data between at least two of CPU memory, GPU memory, or accelerator memory.

Additionally, in accordance with an embodiment of the present disclosure, the method further comprises preparing transfer descriptors based on a transfer request from the transfer agent, and submitting the transfer descriptors to a communication library to interface with the hardware data transfer device and perform the data transfer.

Moreover, in accordance with an embodiment of the present disclosure, the communication library is Universal Communication X (UCX), and the transfer backend plugin acts as an adaptor between the transfer agent and UCX.

Further in accordance with an embodiment of the present disclosure, the hardware data transfer device is a Remote Direct Memory Access (RDMA) device.

Still further in accordance with an embodiment of the present disclosure, the hardware data transfer device is an Ethernet device.

Additionally, in accordance with an embodiment of the present disclosure, the method further comprises supporting non-contiguous data transfers by receiving a transfer request from the transfer agent comprising multiple descriptors, each descriptor corresponding to a portion of non-contiguous data, and translating the request into multiple contiguous transfers for the hardware data transfer device to execute.

Moreover, in accordance with an embodiment of the present disclosure, the method further comprises interfacing with the hardware data transfer device to perform a write or atomic operation transferring data from the local memory to the remote memory, and sending a notification to the remote transfer backend plugin upon completion of the write or atomic operation.

Further in accordance with an embodiment of the present disclosure, the method further comprises interfacing with the hardware data transfer device to perform a read or atomic operation transferring data from the remote memory to the local memory, and sending a notification to the remote transfer backend plugin upon completion of the read or atomic operation.

Still further in accordance with an embodiment of the present disclosure, the method further comprises dynamically loading or unloading the transfer backend plugin during runtime of the transfer agent, allowing flexible adaptation to different hardware data transfer devices and transfer protocols.

### BRIEF DESCRIPTION OF THE DRAWINGS

The present disclosure will be understood from the following detailed description, taken in conjunction with the drawings in which:

FIG. 1 is a simplified pictorial illustration of a computer system constructed and operative in accordance with an embodiment of the present disclosure;

FIG. 2 is a more detailed view of a computer node of FIG. 1;

FIG. 3 is a flowchart including steps in a method of operation of the system of FIG. 1;

FIG. 4 is a simplified block diagram of a system stack in the system of FIG. 1;

FIG. 5 is an example system stack based on a UCX transfer backend plugin for use in the system of FIG. 1;

FIG. 6 is a simplified pictorial illustration of data transfer operations between two nodes of the computer system of FIG. 1;

FIG. 7 is a block diagram illustrating data exchange between local and remote agents in the system of FIG. 1; and

FIG. 8 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### OVERVIEW OF EXAMPLE EMBODIMENTS

Distributed computing environments face significant challenges in efficiently managing memory transfers between nodes, particularly as computational workloads grow in complexity and scale. The heterogeneous nature of modern computing hardware, which may include CPUs, GPUs, and specialized accelerators, adds complexity to coordinating data movement. Additionally, the diverse range of communication protocols and hardware interfaces used in these systems further complicates the process of efficiently transferring data between nodes.

Existing solutions often lack the flexibility to adapt to dynamic system configurations, where nodes may be added or removed on-the-fly. Many current approaches also struggle to provide a unified abstraction layer that can seamlessly handle transfers between different types of memory (including different storage devices and APIs such as block, file, and object storage) locally and/or remotely. This can lead to increased complexity for application developers and potential performance bottlenecks.

Embodiments of the present disclosure address at least some of the above drawbacks by providing a system and method that utilizes a flexible agent-based architecture to manage memory transfers in distributed computing environments. This approach abstracts away the complexities of different memory types and transfer mechanisms, providing a unified interface for applications to initiate and manage data transfers.

In some embodiments, the system includes transfer agents running on each node in the distributed environment. These agents act as intermediaries between user applications and the underlying transfer mechanisms, handling tasks such as memory registration, metadata exchange, and backend selection.

In some cases, the transfer agents utilize a plugin-based architecture that allows for easy integration of different transfer backends. This enables the system to support a wide range of memory types and communication protocols without requiring changes to the core agent logic or application code.

In some embodiments, transfer backend plugins act as adaptors between the transfer agent and hardware data transfer devices. These plugins, such as a UCX transfer backend plugin, may interface with different types of hardware devices, including RDMA and Ethernet devices. In some implementations, the backend plugins may leverage UCX properties to handle tasks such as initializing communication with remote plugins, exchanging address information, and registering local memory for data transfers. In some embodiments, the UCX transfer backend plugin may be replaced with any suitable plugin, such as any suitable accelerated communication library.

The UCX transfer backend plugin may provide a flexible interface for managing data transfers across various types of hardware. This plugin may support multiple transfer protocols, including RDMA over InfiniBand, RDMA over Converged Ethernet (RoCE), TCP/IP, and User Datagram Protocol (UDP). In some cases, the UCX plugin may translate transfer requests from the transfer agent into device-specific commands, allowing for efficient execution of data transfers using the most appropriate protocol for the given hardware configuration.

The solution offers several advantages, including improved flexibility in handling dynamic system configurations, reduced complexity for application developers, and the ability to optimize transfers based on the specific characteristics of the source and destination memory. By providing a consistent abstraction layer across different types of transfers, the system also enhances code portability and reusability.

### SYSTEM DESCRIPTION

In the context of this disclosure, the following definitions apply:

Transfer agent may refer to a software component configured to manage and coordinate data transfers between computer nodes. The transfer agent may register memory, handle transfer requests, exchange metadata with remote nodes, select appropriate transfer backends (e.g., according to the characteristics of the transfer request), and oversee the execution of data transfers.

Transfer backend may refer to a software module or component configured to implement specific data transfer protocols or mechanisms. Transfer backends may be responsible for executing the actual data transfer operations using particular hardware or software interfaces. In some embodiments, the transfer backend may include optimizations specific to inference tasks which involve networking, and to the protocol/mechanism that the transfer backend implements.

Metadata may refer to Information describing the characteristics and capabilities of registered memory and available transfer backends. Metadata may include details such as memory types, address ranges, and supported transfer protocols.

Transfer handle may refer to a data structure generated by the transfer agent to encapsulate information about a specific data transfer request. The transfer handle may include details such as source and destination memory locations for the memory data transfer. In some cases, the transfer handle may be reused for subsequent memory transfers involving the same source and destination memory locations.

Memory (including storage) data transfer may refer to the process of moving data between memory locations (local or remote), which may be within the same computer node or between different computer nodes in a distributed system.

Computer node may refer to a computing device or system that is part of a larger distributed computing environment. A computer node may include processors, memory, and software components such as transfer agents and transfer backends. Processor types may include central processing units (CPUs), graphics processing units (GPUs), data processing units (DPUs), tensor processing units (TPUs), field-programmable gate arrays (FPGAs), and application-specific integrated circuits (ASICs).

Memory may refer to a storage component within a computer node that may include different segments and/or sections of the same memory type and/or different memory types. Memory types can include, but are not limited to, system memory, GPU memory, and non-volatile memory, block, file, and object storage.

User application may refer to a software program or application that utilizes the data transfer capabilities provided by the transfer agent and transfer backends.

Remote computer node may refer to a computer node in the distributed system that is distinct from the local computer node initiating or participating in a data transfer operation.

Application Programming Interface (API) may refer to a set of defined methods and protocols that allow different software components to communicate and interact with each other. In the context of this disclosure, APIs may be used to facilitate communication between the user application, transfer agent, and transfer backends.

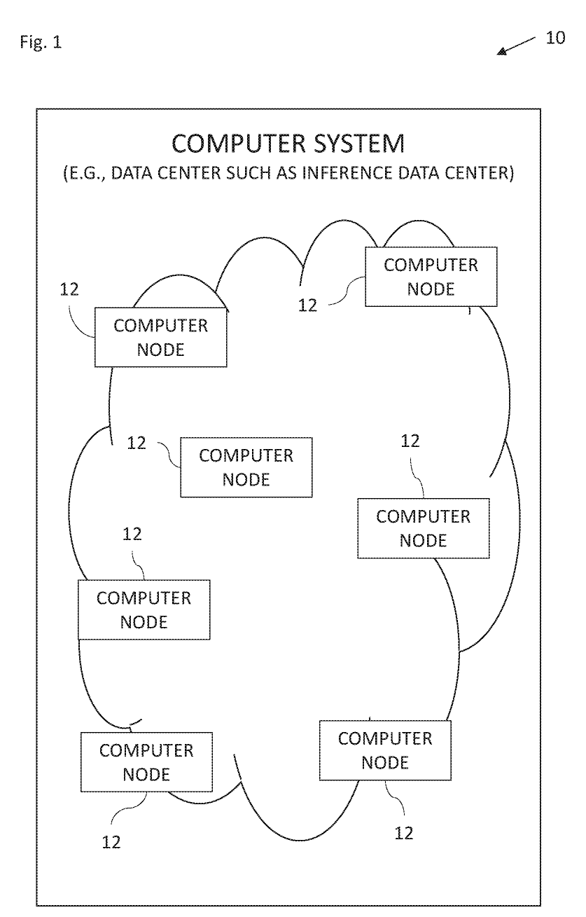

Reference is now made to FIG. 1, which is a block diagram illustrating a computer system 10. The computer system 10 may include multiple computer nodes 12 arranged in a distributed configuration. In some cases, the computer system 10 comprises a first computer node 12 and a second computer node 12. The computer nodes 12 may be interconnected to enable data transfers between them. The cloud symbol shown in FIG. 1 is not meant to be limiting and represents any suitable network topology. It is not limited to a cloud topology.

Each computer node 12 may contain memory resources and processing capabilities for performing computational tasks. In some cases, each computer node 12 comprises at least one processor and memory. The computer nodes 12 may be connected through communication links, allowing the computer nodes 12 to exchange data and coordinate operations within the computer system 10.

In some cases, the computer system 10 may be implemented as a data center environment where the computer nodes 12 work together to process tasks and share resources. The distributed configuration of the computer nodes 12 may allow for scalable and flexible computing capabilities across the computer system 10.

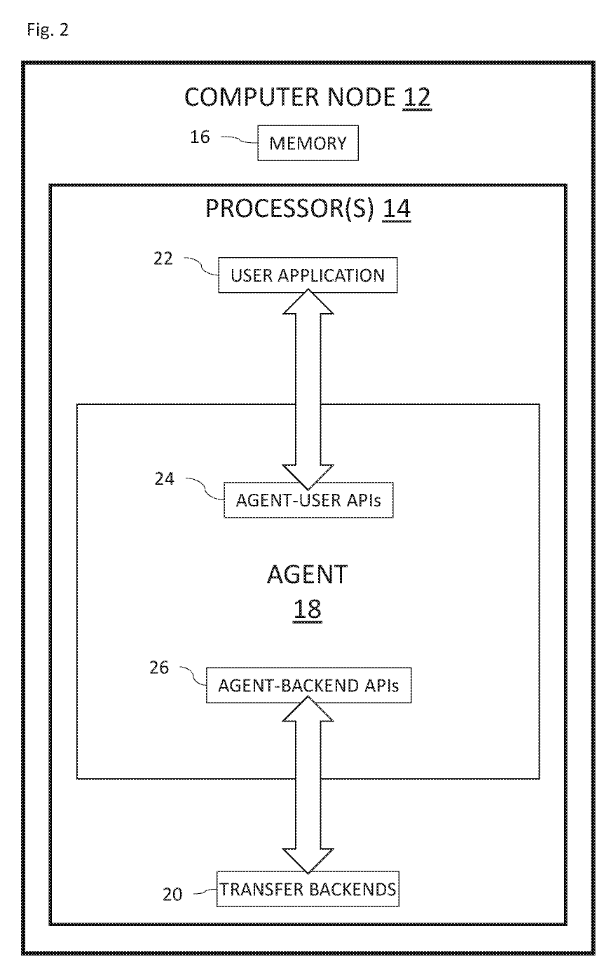

Reference is now made to FIG. 2, which is a block diagram illustrating the architecture of a computer node 12. Computer node 12 may comprise memory 16 and at least one processor 14. The processor(s) 14 may execute a transfer agent 18, a plurality of transfer backends 20, and a user application 22.

The transfer agent 18 may be configured to manage data transfers between local memory 16 and remote computer nodes 12 or between different segments of the local memory 16. For the sake of simplicity, the memory data transfers described herein, are described as local to remote, or remote to local memory data transfers. However, embodiments of the present disclosure also include local to local memory data transfers based on the described embodiments, with suitable changes. In some cases, the transfer agent 18 may register memory 16 for data transfers to generate local metadata. The local metadata may include information about memory types and address ranges of the registered memory 16.

The transfer agent 18 may use a metadata handler component (not shown) to manage metadata exchange and caching. In some implementations, the metadata handler component may be responsible for storing and retrieving both local metadata and remote metadata received from remote transfer agents.

The transfer agent 18 may register the memory 16 of the computer node 12 with one or more of the transfer backends 20. This registration process may involve informing the transfer backends 20 about the available memory resources and their characteristics. The transfer agent 18 may then generate the local metadata for the registered local memory 16 based on the information obtained during the registration process (combining the input parameters provided to the transfer backend(s) and a backend-generated component).

In some cases, the transfer backends may provide specific information about the registered memory to the transfer agent for inclusion in the local metadata. This information may include details such as the memory type (e.g., CPU memory, GPU memory, non-volatile memory), address ranges, access permissions, and alignment requirements.

The transfer backends may also provide performance characteristics of the registered memory, such as bandwidth and latency metrics. In some implementations, the backends may report on the availability of hardware-specific features or optimizations that can be leveraged for data transfers involving particular memory regions.

For GPU memory, the transfer backends may include information about the specific GPU device, such as the device ID, compute capability, and available memory capacity. In the case of storage devices, the backends may provide details on the storage type (e.g., SSD, HDD, NVMe), block size, and any caching mechanisms that may affect transfer performance.

In some aspects, the transfer backends may also include information about the supported transfer protocols and mechanisms for each registered memory. This may encompass details on direct memory access (DMA) capabilities, remote direct memory access (RDMA) support, and any hardware-specific transfer acceleration features.

The local metadata generated by the transfer agent may incorporate this backend-provided information along with additional details gathered from the system configuration and runtime environment. By combining these various sources of information, the transfer agent may create a comprehensive metadata profile for each registered memory, enabling more informed decisions when selecting transfer backends and optimizing data transfer operations.

The transfer agent 18 may abstract away different types of memory and storage through a unified API. This abstraction may allow the user application 22 to interact with various memory types and storage systems using a consistent interface, regardless of the underlying hardware or protocols.

In some implementations, the transfer agent 18 may use a plugin manager to dynamically load and unload transfer backend plugins simplifying the process for the system 10. This feature may allow for flexibility in adding or removing transfer capabilities without requiring changes to the core transfer agent 18 or user application 22.

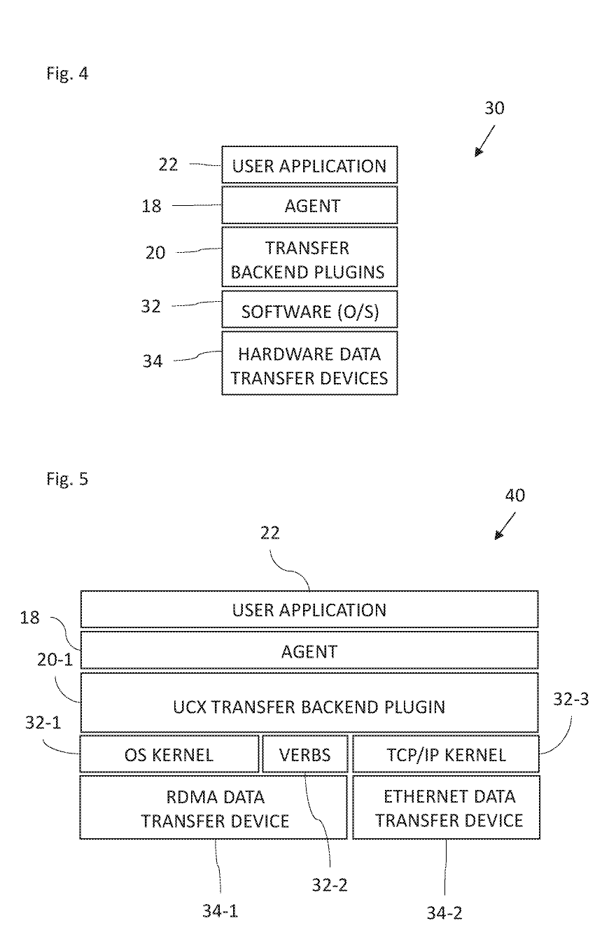

The transfer backends 20 may implement different data transfer protocols and mechanisms. Each transfer backend 20 may be specialized for a particular type of data transfer or memory system. The transfer agent 18 may select an appropriate transfer backend 20 based on the requirements of a specific data transfer request and the available resources. The transfer backends 20 are typically plugins or adapters disposed between the transfer agent 18 and respective hardware configured to implement the different transfer protocols. In some embodiments, the hardware may be an RDMA device or an Ethernet device, for example. There may be one or more layers of software disposed between the transfer backends 20 and the hardware devices. The intervening software may include UCX, an operating system kernel, TCP/IP kernel, Verbs, and CUDA, by way of example. Any suitable software may be included. The transfer backends 20 are described in more detail with reference to FIG. 4.

The transfer agent 18 may provide an abstraction layer that hides implementation details of different transfer backends 20 from the user application 22. This abstraction may simplify the development of user applications by providing a consistent interface for data transfer operations, regardless of the underlying transfer mechanisms.

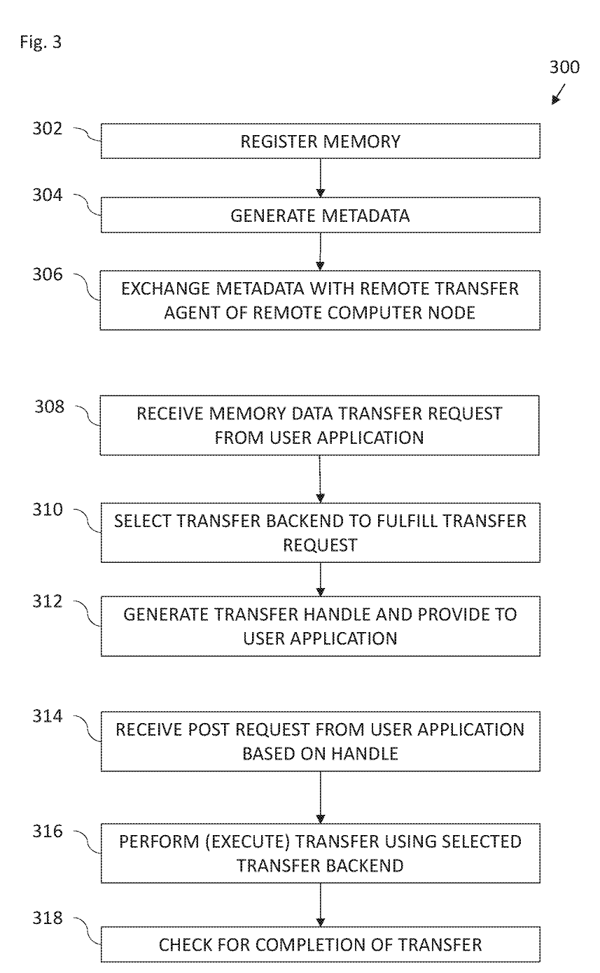

The user application 22 may interact with the transfer agent 18 through agent-user APIs 24. These APIs may provide functions for operations such as registering memory, creating transfer requests, and identifying transfer completion. The agent-user APIs 24 may serve as the primary interface for the user application 22 to initiate and manage data transfers. APIs are described in more detail with reference to FIG. 3.

The transfer agent 18 may communicate with the transfer backends 20 through agent-backend APIs 26. These APIs may define the interface between the transfer agent 18 and the transfer backends 20, allowing for coordination of data transfer operations and exchange of metadata.

In some cases, the local metadata generated by the transfer agent 18 may be exchanged with remote transfer agents of other computer nodes. This exchange may facilitate the selection of compatible transfer backends between different computer nodes for efficient data transfers.

In some embodiments, the system further provides functionality for estimating the cost or duration of a memory data transfer prior to execution. The local transfer agent may be configured to receive a request from the user application to provide an estimate of the transfer cost, such as expected transfer time or resource utilization, for a specified memory data transfer. In certain implementations, this estimate may be obtained by querying the transfer handle associated with the transfer request. The transfer handle, which encapsulates information about the source and destination memory locations, data size, and selected transfer backend, may be used by the transfer agent or the transfer backend to calculate an estimated transfer cost or duration. The transfer agent may generate this estimate based on parameters including the size of the data to be transferred, the characteristics of the selected transfer backend, current system load, and network conditions. Alternatively, the transfer agent may request the transfer backend to provide a backend-specific estimate, or may use a heuristic calculation based on historical transfer performance. This capability enables user applications to make informed decisions regarding data movement, optimize scheduling, and improve overall system efficiency.

Reference is now made to FIG. 3, which is a flowchart illustrating a method 300 for managing memory transfers between computer nodes 12. The method 300 may be performed by local transfer agent 18 in one of the computer nodes 12. The method 300 may be divided into three sub-methods, for example, a registration control flow sub-method (steps 302-306), a handle creation sub-method (308-312), and a data path sub-method (314-318).

The method 300 begins at step 302 with registering local memory 16 that may be involved in data transfers. This registration process generates data to be used as local metadata (see step 304), which may include information about memory types and address ranges of the registered memory.

At step 304, the method 300 involves generating local metadata.

The method 300 proceeds to step 306, which involves exchanging metadata with a remote transfer agent of the remote computer node 12. As part of step 306, remote metadata of the remote transfer agent is received from the remote transfer agent and/or local metadata is provided to the remote transfer agent. This remote metadata may provide information about the memory resources and transfer capabilities of the remote computer node.

At step 308, the method 300 involves receiving a memory data transfer request from user application 22. This request may specify source and destination memory locations for the transfer, which may involve transferring data to or from a remote computer node 12.

At step 310, the method 300 involves selecting a transfer backend to fulfill the transfer request. The selection is based on the exchanged metadata between the local and remote nodes. The local transfer agent may analyze the local metadata and remote metadata to determine compatible transfer backends between the computer node and the remote computer node. In some cases, the local transfer agent may select one of the transfer backends based on memory types involved in the request, such as system memory, GPU memory, or storage. One possible selection criterion may be based on the efficiency of memory transfer.

The method 300 then moves to step 312, where a transfer handle is generated and provided to the user application. The transfer handle may be a data structure that includes information about source and destination memory locations for the memory data transfer, and the selected transfer backend(s) for performing the memory data transfer.

At step 314, the method 300 involves receiving a post request from the user application based on the provided handle (generated on step 312). This post request initiates the actual transfer operation.

At step 316, the method involves performing the transfer using the selected transfer backend(s). The local transfer agent may prepare transfer descriptors based on the transfer handle and submit these descriptors to the selected transfer backend(s). The transfer backend(s) then executes the transfer according to the parameters specified in the transfer handle.

At step 318, the method includes checking for completion of the transfer to the remote memory. In some cases, the local transfer agent may monitor the progress of the transfer with the selected transfer backend(s). Upon completion of the transfer, the local transfer agent notifies the user application.

The method 300 supports asynchronous non-blocking transfers. After initiating a transfer, the local transfer agent 18 may return control to the user application 22 without waiting for the transfer to complete. This allows the user application 22 to continue execution while the transfer is in progress.

In some implementations, the transfer agent 18 may support reposting transfers using the same handle without recreating it. This feature may be useful for repetitive transfers involving the same source and destination memory locations, potentially improving efficiency for certain use cases.

The method 300 provides a flexible and efficient approach to managing memory transfers between computer nodes. By abstracting the details of different transfer backends and providing a unified interface, the method 300 may simplify the implementation of distributed memory operations in complex computing environments.

In some cases, processor(s) 14 may execute a plurality of transfer backends 20. The transfer backends 20 implement different data transfer protocols and mechanisms to enable efficient memory transfers between computer nodes. Each transfer backend may be specialized for handling specific types of memory or communication protocols.

The user application may reuse a transfer handle for at least one subsequent memory transfer involving the same source and destination memory locations. A transfer handle may be a data structure that includes information about source and destination memory locations for the memory data transfer. By reusing the transfer handle, the user application can avoid recreating transfer requests for repeated transfers between the same memory locations, potentially improving efficiency.

In some cases, the transfer backends may implement specific APIs to be pluggable into the transfer agent. These APIs may define a standard interface that allows different transfer backends to be integrated with the transfer agent. The APIs may include functions for initializing the backend, registering and deregistering memory, submitting transfer descriptors, identifying transfer completion, and notifying the transfer agent of transfer completion.

The transfer agent may support different modes of metadata exchange between computer nodes. In some cases, a side channel may be used for metadata exchange, where computer nodes directly exchange metadata with each other. Alternatively, a centralized metadata server may be employed, where computer nodes send their metadata to a central location and retrieve metadata for other nodes from this centralized server. The choice of metadata exchange mode may depend on factors such as network topology, scalability requirements, and system configuration.

Local metadata may include information about memory types and address ranges of registered local memory, and transfer backend(s) that support the respective memory. This metadata may be generated by the transfer agent when registering memory with one or more transfer backends. The local metadata may be used to determine which transfer backends are capable of handling specific memory regions.

Remote metadata may contain similar information about memory types, address ranges, and backend(s) that support the respective memory, but for the memory of a remote computer node. The transfer agent may receive this remote metadata from a remote transfer agent during the metadata exchange process. The remote metadata allows the local transfer agent to understand the memory capabilities, configurations and access information of the remote node, enabling informed decisions about compatible transfer backends and efficient data transfer paths.

The local transfer agent uses application programming interfaces (APIs) to interface with the user application and the transfer backends. These APIs may be categorized into two main groups: agent-user APIs and agent-backend APIs.

A set of agent-user APIs may provide an interface between the local transfer agent and the user application. These APIs may include functions for various operations related to memory management and data transfer. In some cases, the agent-user APIs may include the following functions:

1. Register Memory: This function may allow the user application to register memory regions for data transfers. The function may take inputs such as memory address, size, and memory type. The output may be a memory handle or identifier.

2. Deregister Memory: This function may allow the user application to deregister previously registered memory regions. The input may be the memory handle or identifier, and the output may be a status indicating successful deregistration.

3. Create Transfer Request: This function may enable the user application to create a data transfer request. Inputs may include source and destination memory handles, transfer size, and transfer operation (e.g., read, write, atomic, or more complex application-specific operations). The output may be a transfer handle.

4. Post Transfer Request: This function may allow the user application to initiate a previously created transfer request. The input may be the transfer handle, and the output may be a status indicating whether the transfer was successfully posted.

5. Check Transfer Status: This function may enable the user application to check the status of an ongoing transfer. The input may be the transfer handle, and the output may be the current status of the transfer (e.g., in progress, completed, or failed).

6. Release Transfer Handle: This function may allow the user application to release a transfer handle when it is no longer needed. The input may be the transfer handle, and the output may be a status indicating successful release.

A set of agent-backend APIs may provide an interface between the local transfer agent and the transfer backends. These APIs may include functions for managing backend operations and coordinating data transfers. In some cases, the agent-backend APIs may include the following functions:

1. Initialize Backend: This function may initialize a specific transfer backend. The input may be backend-specific configuration parameters, and the output may be a status indicating successful initialization.

2. Register Memory with Backend: This function may register memory regions with a specific backend. Inputs may include memory address, size, and memory type. The output may be a backend-specific memory handle.

3. Deregister Memory from Backend: This function may deregister previously registered memory regions from a specific backend. The input may be the backend-specific memory handle, and the output may be a status indicating successful deregistration.

4. Submit Transfer Descriptor: This function may submit a transfer descriptor to a specific backend for execution. Inputs may include source and destination memory handles, transfer size, and transfer type. The output may be a backend-specific transfer identifier.

5. Check Transfer Completion Status: This function may check the completion status of a transfer submitted to a specific backend. The input may be the backend-specific transfer identifier, and the output may be the current status of the transfer.

6. Notify Transfer Completion: This function may allow the backend to notify the local transfer agent when a transfer is completed. The input may be the backend-specific transfer identifier and completion status, and the output may be an acknowledgment from the local transfer agent.

In some cases, these APIs may provide a standardized interface for communication between the local transfer agent, user application, and transfer backends, enabling efficient and flexible management of data transfers across different memory types and transfer protocols.

In some cases, the local transfer agent may dynamically add or remove transfer backends during runtime. When adding or removing backends, the transfer agent may update the local metadata to reflect the changes in available transfer capabilities. The updated metadata may then be propagated to remote transfer agents to ensure all nodes have current information about transfer capabilities. This capability allows the system to adapt to changing requirements or resource availability without requiring a system restart. For example, a new transfer backend supporting a novel communication protocol may be added to the system while it is operational. Similarly, an underutilized or malfunctioning transfer backend may be removed from the system without disrupting ongoing operations.

When a new transfer backend is added, the local transfer agent may register the new backend and update its local metadata to reflect the additional capabilities. This updated metadata may include information about the new backend's supported memory types, transfer protocols, or performance characteristics. Conversely, when a transfer backend is removed, the local transfer agent may update its local metadata to remove references to the decommissioned backend.

In some implementations, the local transfer agent may propagate the updated metadata to remote transfer agents. This propagation ensures that all nodes in the system have up-to-date information about available transfer backends and their capabilities. The metadata propagation may occur through a dedicated control channel or may be piggybacked on existing communication between nodes. In some embodiments, the metadata may be stored by a centralized metadata service which is updated by the transfer agents. During backend removal, the user application may perform additional synchronization steps to ensure that all transfer agents that may perform communication via this transfer backend are notified before the backend is removed. This procedure can, for example, be performed by leveraging existing notification infrastructure by implementing Backend Removal Acknowledgement notifications.

The system may also support dynamically adding and removing nodes or agents at runtime. This flexibility allows for scaling the system up or down based on workload demands or resource availability and avoids over-provisioning (which may be damaging for interference workloads due to the dynamic nature of inference). When a new node is added to the system, its local transfer agent may register with existing nodes and exchange metadata. Similarly, when a node is removed, the remaining nodes may update their metadata to reflect the change in system topology.

Alternative embodiments of the system may include variations in the system architecture. For example, instead of a fully distributed architecture where each node has its own transfer agent, a hierarchical architecture may be implemented. In this alternative, a central coordinator node may manage metadata exchange and backend selection for a group of worker nodes.

Reference is now made to FIG. 4, which shows a system stack 30 architecture comprising multiple layers that enable efficient data transfers between computer nodes 12. The stack 30 includes user application 22 at the top layer. The user application 22 interacts with transfer agent 18, which provides an abstraction layer for managing data transfers.

Below the transfer agent 18 are transfer backends 20. The transfer backends 20 implement different data transfer protocols and mechanisms, as described previously. The stack 30 also includes software layers 32, which may comprise an operating system (OS) and other software, described in more detail with reference to FIG. 5. At the bottom of the stack 30 are hardware data transfer devices 34. These enable physical transmission of data between computer nodes 12.

Reference is now made to FIG. 5, which shows an example system stack 40 based on a Unified Communication X (UCX) transfer backend plugin 20-1. The stack 40 includes user application 22, transfer agent 18, and UCX transfer backend plugin 20-1. The software layer includes an operating system (OS) kernel 32-1, a Transmission Control Protocol (TCP)/Internet Protocol (IP) kernel 32-3, and an InfiniBand (IB) Verbs layer 32-2. The hardware layer includes an RDMA data transfer device 34-1 and an Ethernet data transfer device 34-2. In some embodiments, the UCX transfer backend plugin 20-1 may be replaced by any suitable transfer backend plugin.

The UCX transfer backend plugin 20-1 acts as an adaptor between the transfer agent 18 and the hardware data transfer devices 34. It can interface with the RDMA data transfer device 34-1 and/or the Ethernet data transfer device 34-2.

The UCX transfer backend plugin 20-1 may interface with CUDA to access graphics processing unit (GPU) memory when needed for data transfers involving GPUs. When RDMA hardware is not available, the UCX transfer backend plugin 20-1 can fall back to using TCP/IP for data transfers, for example.

By organizing components into this layered architecture, as illustrated in FIGS. 4 and 5, the system enables efficient and flexible data transfers while abstracting complexity from user applications 22.

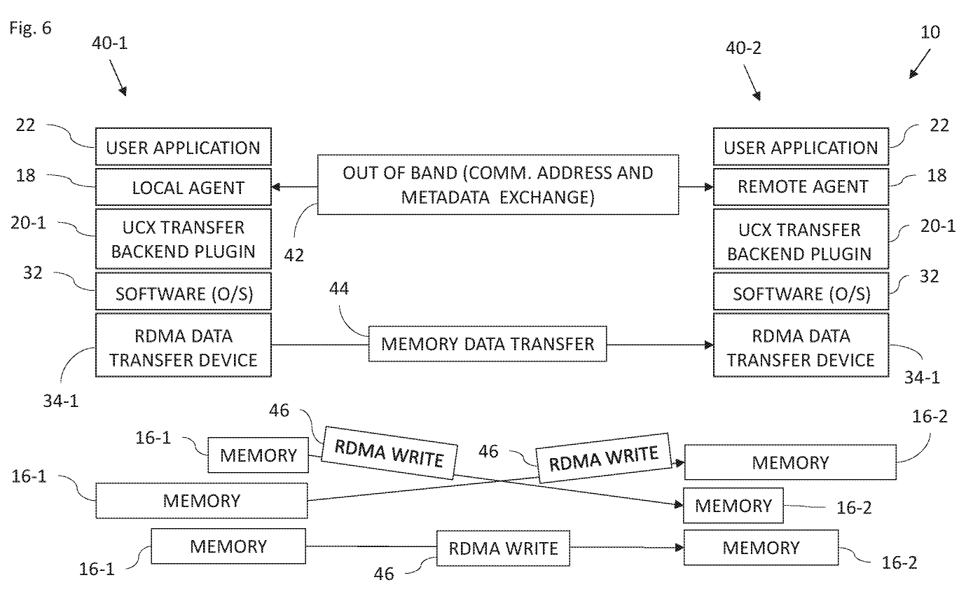

Reference is now made to FIG. 6, which is a block diagram of computer system 10 showing data transfer operations between two nodes. The computer system 10 includes a stack 40-1 of a local node and a stack 40-2 of a remote node configured to enable memory data transfers between them.

The local node stack 40-1 includes user application 22, transfer agent 18, and UCX transfer backend plugin 20-1. Below these components are software 32 (e.g., operating system, IB Verbs, CUDA) and a RDMA data transfer device 34-1. The local node stack 40-1 has access to memory 16-1, which are part of the local node.

The remote node stack 40-2 has a similar architecture with access to memory 16-2 of the remote node. The nodes perform a data exchange 42 between their respective transfer agents 18 and UCX transfer backend plugins 20-1 as part of setup and as a preliminary stage prior to memory data transfer between the RDMA data transfer device 34-1 of the local node and remote node. In some embodiments, the UCX transfer backend plugin 20-1 may be replaced by any suitable transfer backend plugin.

The transfer agent 18 may register memory for data transfers to generate local metadata. This local metadata may comprise information about memory types and address ranges. The transfer agent 18 of the local node may receive from the user application 22 of the local node, a request to perform a memory data transfer to (or from) the remote node. In some cases, a memory data transfer may occur between the memory of a single node.

The transfer agent 18 of the local node may receive remote metadata from the transfer agent 18 of the remote node as part of the data exchange 42. The transfer agent 18 of the local node may analyze the local metadata and remote metadata to determine compatible transfer backends between the local node and the remote node. Based on this analysis, the transfer agent 18 may select a transfer backend to fulfill the memory data transfer. The selection may be based on memory types involved in the request.

The diagram shows a memory data transfer 44 being performed between the nodes. The memory data transfer 44 includes RDMA write 46 operations from memory 16-1 by the RDMA data transfer device 34-1 of the local node to the memory 16-2 by the RDMA data transfer device 34-1 of the remote node. The RDMA “write” operation type is used by way of example. Embodiments of the present disclosure may include any suitable operation type.

The transfer agents 18 coordinate with their respective UCX transfer backend plugins 20-1 to manage the data transfer operations. In some cases, the UCX transfer backend plugin 20-1 may use zero-copy data transfers to improve performance.

The transfer agent 18 of the local node may monitor progress of the transfer with the selected transfer backend. Upon completion of the transfer, the transfer agent 18 may notify the user application 22.

In some implementations, the transfer agent 18 may batch multiple transfer requests together for improved efficiency. The transfer agent 18 may also use a progress thread to ensure asynchronous transfer.

The transfer requests processed by the system may include multiple descriptors, each referring to different local and remote memory sections. These descriptors allow for flexible and efficient data transfer operations between various memory locations.

In some implementations, the memory sections specified by the descriptors may be of uniform size. However, the system also supports descriptors referencing memory sections of different sizes, as illustrated in FIG. 6. This flexibility enables the system to handle diverse data transfer requirements, accommodating varying memory layouts and data structures across different nodes.

The system may support various one-sided operations: RDMA write, read, and atomic operations as well as complex non-standard application-specific operations. RDMA write operations involve transferring data from the local node's memory to the remote node's memory, while RDMA read operations retrieve data from the remote node's memory to the local node's memory. IB verbs atomic operations allow modifying a remote node’s memory atomically with respect to other communication peers. In addition, Remote Direct Memory Operations (RDMOs) that extend the set of atomic operations beyond the IB verbs specification can be applied similarly to RDMA read, write and atomic operations.

Any suitable operation may be performed with or without notification. Notifications may play a role in ensuring efficient memory management and synchronization between nodes.

For write operations, notifications are important because they inform the receiving application when the transferred data is ready for consumption. Without notifications, the receiving application may not know precisely when the data has been fully written to its memory, potentially leading to race conditions or data inconsistencies.

In the case of read operations, notifications notify the remote side that the data has been consumed, and the remote system can reuse the buffer space for subsequent operations, optimizing memory utilization.

The importance of notifications becomes particularly evident in scenarios involving non-contiguous data transfers. When a transfer request comprises multiple descriptors, each corresponding to a portion of non-contiguous data, once all parts of the data have been successfully transferred, a single notification signaling completion of the transfer is sent to the user application.

In some embodiments, complex data transfers may be optimized by leveraging patterned memory accesses and restructuring, e.g., batching. In some embodiments, the transfer agent may enable data movement between a source and a target which are not directly “connected”, e.g., via forwarding.

The system described in FIG. 6 may be part of a larger system comprising multiple computer nodes, each with a similar structure and functionality as described above. In such a system, each node may have a transfer agent 18 that registers memory for data transfers to generate local metadata, receives transfer requests from a user application 22, exchanges metadata with remote nodes, selects appropriate transfer backends, and performs memory data transfers using the selected backends.

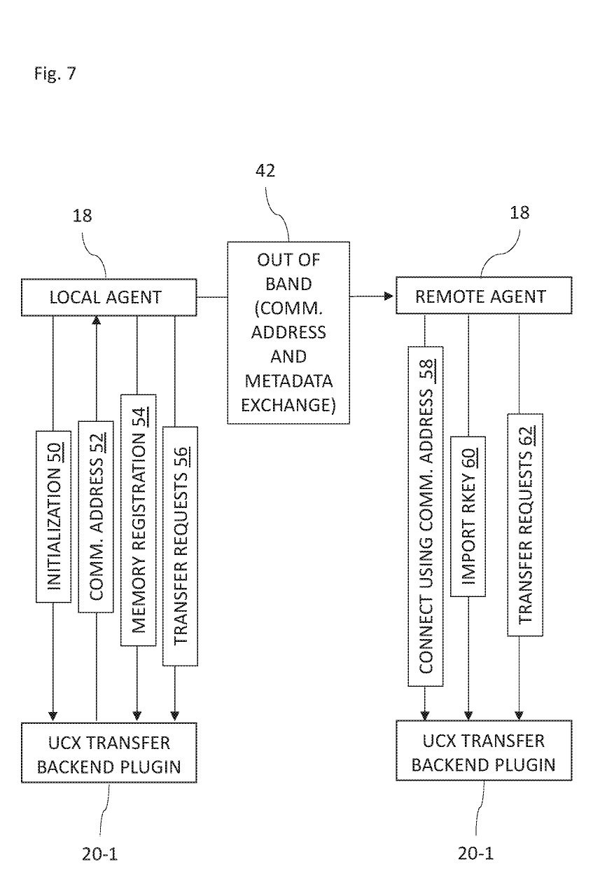

Reference is now made to FIG. 7, which is a block diagram illustrating the functionality of transfer backend plugin 20-1 in a data transfer system. The system includes a local transfer agent 18 and a remote transfer agent 18 that communicate through a data exchange 42.

The local transfer agent 18 connects to UCX transfer backend plugin 20-1 of the local node. The UCX transfer backend plugin 20-1 of the local node performs several key functions in the data transfer process. Initially, the UCX transfer backend plugin 20-1 receives an initialization 50 request from the local transfer agent 18. In response, the UCX transfer backend plugin 20-1 generates and provides its communication address 52 to the local transfer agent 18. The local transfer agent 18 may then share this communication address with the remote transfer agent 18 through the data exchange 42. This exchange of communication addresses allows the local and remote nodes to establish a connection for data transfers. In some embodiments, the UCX transfer backend plugins 20-1 may be replaced by any suitable transfer backend plugins.

The UCX transfer backend plugin 20-1 also handles memory registration 54 based on data received about memory of the local node from the local transfer agent 18. Memory registration involves preparing specific memory regions for efficient data transfer operations. In some cases, the local transfer agent 18 may register the memory of the computer node with one or more transfer backends, including the UCX transfer backend plugin 20-1. The local transfer agent 18 may generate local metadata for the registered local memory, which may include information about memory types and address ranges. The memory registration metadata may be shared with the remote agent in exchange 42 in order to enable the remote agent to perform communication operations towards the local agent.

Once the initialization, address exchange, and memory registration processes are complete, the UCX transfer backend plugin 20-1 is ready to process transfer requests 62 received from the local transfer agent 18. These transfer requests may be based on transfer handles generated by the local transfer agent 18.

When processing a transfer request, the local transfer agent 18 may prepare transfer descriptors based on the transfer handle and submit these transfer descriptors to the UCX transfer backend plugin 20-1. The UCX transfer backend plugin 20-1 then interfaces with the hardware data transfer device to perform the actual data transfer using the appropriate transfer protocol.

In the transfer process, the remote transfer agent 18 and remote UCX transfer backend plugin 20-1 perform complementary functions to those of their local counterparts. As part of the data exchange 42, the remote transfer agent 18 receives the communication address 52 of the local node's UCX transfer backend plugin 20-1. Upon receiving this address, the remote transfer agent 18 may instruct its UCX transfer backend plugin 20-1 to connect using the communication address 58 of the local node. This establishes a direct communication channel between the local and remote UCX transfer backend plugins. After the connection is established, the remote UCX transfer backend plugin 20-1 may import a remote key (RKEY) 60. The RKEY 60 may be used for subsequent communications and data transfer operations between the local and remote nodes. This key may provide necessary access permissions and memory addressing information for efficient RDMA operations. The remote transfer agent 18 may also handle memory registration on its node, similar to the process performed by the local transfer agent 18. This may involve registering local memories with the remote UCX transfer backend plugin 20-1 and generating metadata about these registered memories. When communication is initiated by the remote application, the remote transfer agent 18 may coordinate via transfer requests 62 with UCX transfer backend plugin 20-1 (of the remote node) to process these requests. This may involve preparing the appropriate memory regions for incoming data in the case of write operations, or retrieving and sending data in the case of read operations. The remote UCX transfer backend plugin 20-1 may interface with the RDMA data transfer device (of the remote node) to execute the actual data transfers, whether receiving data from or sending data to the local node. Throughout the transfer process, the remote transfer agent 18 and its UCX transfer backend plugin 20-1 may work in concert with their counterparts (of the local node) to ensure efficient and synchronized data movement between the nodes.

In some cases, the UCX transfer backend plugin 20-1 (or any other suitable transfer backend plugin) may translate transfer requests from the transfer agent 18 into device-specific commands. This translation process may involve interpreting the high-level transfer descriptors provided by the transfer agent 18 and converting them into low-level instructions that can be directly executed by the hardware data transfer devices 34.

The UCX transfer backend plugin 20-1 may analyze the characteristics of the transfer request, such as the memory types involved, the size of the data to be transferred, and the current network conditions. Based on this analysis, the plugin may select the most appropriate transfer protocol and optimize the transfer parameters for the specific hardware configuration.

For example, when dealing with GPU memory transfers, the UCX transfer backend plugin 20-1 may leverage UCX properties to generate CUDA-specific commands to efficiently move data to or from GPU memory. In cases where RDMA hardware is available, the plugin may leverage UCX properties to create RDMA verbs commands to take advantage of the high-performance capabilities of the RDMA data transfer device 34-1. Alternatively, if the transfer involves standard system memory and RDMA is not available, the plugin may leverage UCX properties to fall back to generating TCP/IP socket operations for the Ethernet data transfer device 34-2.

This translation capability allows the UCX transfer backend plugin 20-1 to act as a flexible intermediary between the abstract transfer requests generated by the transfer agent 18 and the specific requirements of various hardware devices. By adapting the transfer execution to the available hardware and network conditions, the plugin may help ensure efficient data transfers across a wide range of system configurations.

On the remote side, the remote transfer agent 18 connects to its own UCX transfer backend plugin 20-1. The remote plugin receives the communication address of the local node (block 58) and uses this information to establish a connection. The remote plugin also imports a remote key (RKEY) 60, which may be used in subsequent communications and data transfers.

The UCX transfer backend plugin 20-1 supports various transfer protocols, which may include Remote Direct Memory Access (RDMA) over InfiniBand, RDMA over Converged Ethernet (RoCE), TCP/IP, User Datagram Protocol (UDP), or shared memory transfers. This flexibility allows the plugin to act as an interface between the transfer agent and different types of hardware data transfer devices implementing these protocols.

In some cases, the UCX transfer backend plugin 20-1 may support non-contiguous data transfers. When receiving a transfer request comprising multiple descriptors, each corresponding to a portion of non-contiguous data, the plugin may translate the request into multiple contiguous transfers for the hardware data transfer device to execute. In some embodiments, the UCX transfer backend plugin 20-1 may leverage device offload capabilities to transfer non-contiguous data as part of a single HW transfer request, when such a transfer is supported by the hardware data transfer device.

The local transfer agent 18 may use application programming interfaces (APIs) to interface with the user application and the transfer backends, including the UCX transfer backend plugin 20-1. The APIs associated with the transfer backends may include functions for backend initialization, registering memory with the backend, deregistering memory from the backend, submitting a transfer descriptor, identifying transfer completion, or sending notifications to the remote transfer agents.

In some implementations, the local transfer agent 18 may dynamically add or remove transfer backends during runtime. When adding or removing transfer backends, the local transfer agent 18 may update the local metadata and propagate the updated metadata to remote transfer agents.

The UCX transfer backend plugin 20-1 may be configured to send notifications upon completion of data transfer operations. For example, after performing a write operation transferring data from the local memory to the remote memory, the plugin may send a notification to the remote transfer backend plugin. Similarly, upon completion of a read operation transferring data from the remote memory to the local memory, a notification may be sent to the remote agent to confirm that the data was consumed.

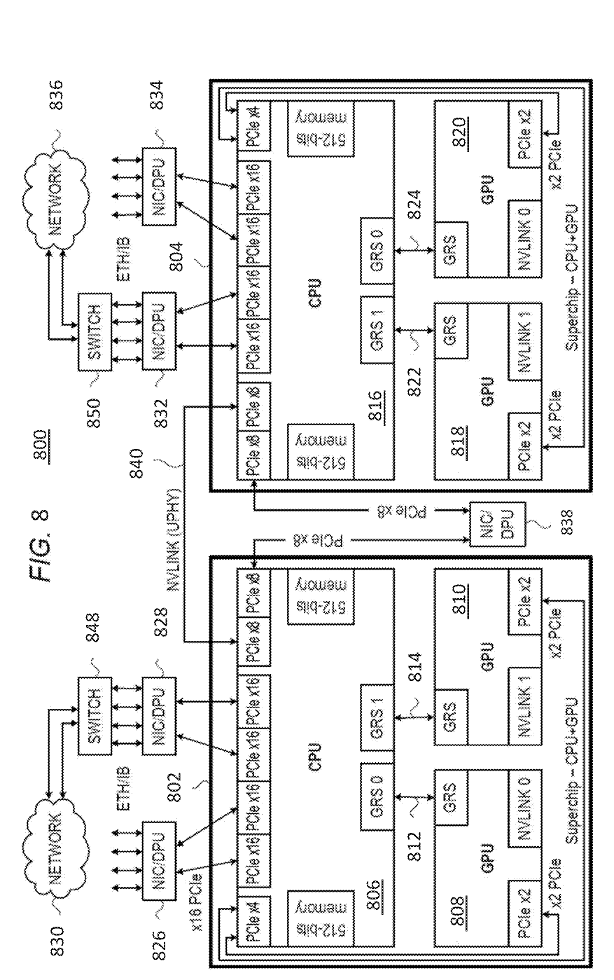

Reference is now made to FIG. 8, which is a block diagram that schematically illustrates a computing system 800, e.g., a data center or a High-Performance Computing (HPC) cluster, in accordance with an embodiment of the present disclosure.

System 800 comprises a plurality of subsystems, e.g., multiple processing devices coupled to each other, multiple network devices, and multiple networks, according to at least one embodiment. Computing system 800 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 800 and to one or more external networks 830, 836. In the present example, system 800 comprises a packet switch 848 that connects NIC/DPU 828 to network 830, and a packet switch 850 that connects NIC/DPU 832 to network 836.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 800 can include one or more CPUs and one or more GPUs.

FIG. 8 also demonstrates an example architecture of a multi-GPU architecture. As illustrated in the figure, computing system 800 includes a processing device 802 with a multi-GPU architecture. In particular, processing device 802 may be a system-on-chip and includes multiple subsystems such as a CPU 806, a GPU 808, and a GPU 810. CPU 806 can be coupled to GPU 808 via a die-to-die (D2D) or chip-to-chip (C2C) interconnect 812, such as a Ground-Referenced Signaling interconnect (GRS interconnect). CPU 806 can be coupled to GPU 810 via a D2D or C2C interconnect 814. CPU 806 can also couple to GPU 808 and GPU 810 via PCIe interconnects.

CPU 806 can be coupled to one or more NICs or DPUs, which are coupled to one or more networks. For example, as illustrated in FIG. 8, CPU 806 is coupled to a first NIC/DPU 826, which is coupled to a network 830. CPU 806 is also coupled to a second NIC/DPU 828, which is coupled to network 830 via switch 848. NIC/DPU 826 and NIC/DPU 828 can be coupled to network 830 over Ethernet (ETH), NVLINK or InfiniBand (IB) connections, for example.

Computing system 800 also includes a processing device 804 with a multi-GPU architecture. In particular, processing device 804 includes multiple subsystems including a CPU 816, a GPU 818, and a GPU 820. CPU 816 can be coupled to GPU 818 via a D2D or C2C interconnect 822. CPU 816 can be coupled to GPU 820 via a D2D or C2C interconnect 824. CPU 816 can also couple to GPU 818 and GPU 820 via PCIe interconnects. CPU 816 can be coupled to one or more NICs or DPUs, which are coupled to one or more networks. For example, as illustrated in FIG. 8, CPU 816 is coupled to a first NIC/DPU 832, which is coupled to a network 836. CPU 816 is also coupled to a second NIC/DPU 834, which is coupled to network 836 via switch 850. NIC/DPU 832 and NIC/DPU 834 can be coupled to network 836 over Ethernet (ETH), NVLINK or InfiniBand (IB) connections.

In at least one embodiment, processing device 802 and processing device 804 can communicate with each other via a NIC/DPU 838, such as over PCIe interconnects. Processing device 802 and processing device 804 can also communicate with each other over a high-bandwidth communication interconnect 840, such as an NVLink interconnect or other high-speed interconnects. The packet switches in FIG. 8 may comprise, for example, Nvidia Quantum-2 switches. The NICs/DPUs in the figure may comprise, for example, Nvidia Bluefield DPUs.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form "a", "an" and "the" include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A device, comprising:
at least one processor to execute a transfer backend plugin acting as an adaptor between a transfer agent and a hardware data transfer device, the transfer backend plugin being to:
initialize communication with a remote transfer backend plugin;
exchange address information with the remote transfer backend plugin;
register local memory for data transfers;
exchange memory registration information with the remote transfer backend plugin; and
interface with the hardware data transfer device to perform data transfers between the local memory and remote memory using at least one data transfer protocol; and
a memory to store data used by the transfer backend plugin.

2. The device of claim 1, wherein the transfer backend plugin is to:
receive a transfer request from the transfer agent, the transfer request including information about source and destination memory locations; and
translate the transfer request into device-specific commands to execute the transfer using a selected transfer protocol.

3. The device of claim 2, wherein the transfer backend plugin supports multiple transfer protocols including at least one of Remote Direct Memory Access (RDMA) over InfiniBand, RDMA over Converged Ethernet (RoCE), TCP/IP, User Datagram Protocol (UDP), or shared memory transfers, acting as an interface between the transfer agent and hardware data transfer devices implementing these protocols.

4. The device of claim 1, wherein the transfer backend plugin is to interface with different types of memory to transfer data between at least two of CPU memory, GPU memory, or accelerator memory.

5. The device of claim 1, wherein the transfer backend plugin is to:
prepare transfer descriptors based on a transfer request from the transfer agent; and
submit the transfer descriptors to a communication library to interface with the hardware data transfer device to perform the data transfer.

6. The device of claim 5, wherein the communication library is Universal Communication X (UCX), and the transfer backend plugin acts as an adaptor between the transfer agent and UCX.

7. The device of claim 6, wherein the hardware data transfer device is a Remote Direct Memory Access (RDMA) device.

8. The device of claim 6, wherein the hardware data transfer device is an Ethernet device.

9. The device of claim 1, wherein the transfer backend plugin is to support non-contiguous data transfers by:
receiving a transfer request from the transfer agent comprising multiple descriptors, each descriptor corresponding to a portion of non-contiguous data; and
translating the request into multiple contiguous transfers for the hardware data transfer device to execute.

10. The device of claim 1, wherein the transfer backend plugin is to:
interface with the hardware data transfer device to perform a write or atomic operation transferring data from the local memory to the remote memory; and
send a notification to the remote transfer backend plugin upon completion of the write or atomic operation.

11. The device of claim 1, wherein the transfer backend plugin is to:
interface with the hardware data transfer device to perform a read or atomic operation transferring data from the remote memory to the local memory; and
send a notification to the remote transfer backend plugin upon completion of the read or atomic operation.

12. The device of claim 1, wherein the transfer backend plugin is dynamically loadable and unloadable during runtime of the transfer agent, allowing adaptation to different hardware data transfer devices and transfer protocols.

13. A method for managing data transfers in a device, comprising:
executing a transfer backend plugin acting as an adaptor between a transfer agent and a hardware data transfer device;
initializing, by the transfer backend plugin, communication with a remote transfer backend plugin;
exchanging address information with the remote transfer backend plugin;
registering local memory for data transfers;
exchanging memory registration information with the remote transfer backend plugin; and
interfacing with the hardware data transfer device to perform data transfers between the local memory and remote memory using at least one data transfer protocol.

14. The method of claim 13, further comprising:
receiving a transfer request from the transfer agent, the transfer request including information about source and destination memory locations; and
translating the transfer request into device-specific commands to execute the transfer using a selected transfer protocol.

15. The method of claim 14, wherein the transfer backend plugin supports multiple transfer protocols including at least one of Remote Direct Memory Access (RDMA) over InfiniBand, RDMA over Converged Ethernet (RoCE), TCP/IP, User Datagram Protocol (UDP), or shared memory transfers, acting as an interface between the transfer agent and hardware data transfer devices implementing these protocols.

16. The method of claim 13, wherein performing data transfers includes interfacing with different types of memory to transfer data between at least two of CPU memory, GPU memory, or accelerator memory.

17. The method of claim 13, further comprising:
preparing transfer descriptors based on a transfer request from the transfer agent; and
submitting the transfer descriptors to a communication library to interface with the hardware data transfer device and perform the data transfer.

18. The method of claim 17, wherein the communication library is Universal Communication X (UCX), and the transfer backend plugin acts as an adaptor between the transfer agent and UCX.

19. The method of claim 18, wherein the hardware data transfer device is a Remote Direct Memory Access (RDMA) device.

20. The method of claim 18, wherein the hardware data transfer device is an Ethernet device.

21. The method of claim 13, further comprising supporting non-contiguous data transfers by:
receiving a transfer request from the transfer agent comprising multiple descriptors, each descriptor corresponding to a portion of non-contiguous data; and
translating the request into multiple contiguous transfers for the hardware data transfer device to execute.

22. The method of claim 13, further comprising:
interfacing with the hardware data transfer device to perform a write or atomic operation transferring data from the local memory to the remote memory; and
sending a notification to the remote transfer backend plugin upon completion of the write or atomic operation.

23. The method of claim 13, further comprising:
interfacing with the hardware data transfer device to perform a read or atomic operation transferring data from the remote memory to the local memory; and
sending a notification to the remote transfer backend plugin upon completion of the read or atomic operation.

24. The method of claim 13, further comprising dynamically loading or unloading the transfer backend plugin during runtime of the transfer agent, allowing flexible adaptation to different hardware data transfer devices and transfer protocols.
